(19) United States
(12) Patent Application Publication
(10) Pub. No.: US 2011/0119595 A1
(43) Pub. Date: May 19, 2011

(54) Apparatus and Method for Browser Based Integration of Broadcast Television and Internet Content

(75) Inventors: David Kenneth Bydeley, San Jose, CA (US); Patricia Margaret Birks, Fremont, CA (US); Vernon Carter Marshall, San Francisco, CA (US)

(73) Assignee: Telegent Systems USA, Inc.

(21) Appl. No.: 12/622,368

(22) Filed: Nov. 19, 2009

(51) Int. Cl. G06F 15/16; G06F 3/048

(52) U.S. Cl. 715/738; 709/231; 725/112; 715/760; 715/758

(57) ABSTRACT

A computer readable storage medium includes executable instructions to adapt live broadcast content for display within a browser. The live broadcast content is displayed within the browser. Internet content related to the live broadcast is also supplied within the browser. Television events that include live broadcast content and corresponding internet content are shared by a group of users. Broadcast content and internet content consumption is tracked.

### FIELD OF THE INVENTION

This invention relates generally to the electronic distribution of media content. More particularly, this invention relates to a browser based integration of broadcast television and internet content.

### BACKGROUND OF THE INVENTION

A web browser is a software application for traversing, retrieving and presenting information resources on the World Wide Web. One resource that may be accessed with a web browser is streamed video content. Traditionally, web sites provide this content to a client computer by streaming it over the Internet using a dedicated connection or pipe. Each user who wants to watch the video content secures a dedicated connection. If many users want to watch the same content at the same time, it results in duplicated data being sent to each user's computer. When a major event or a special program is being shown, this solution does not scale well and results in over all poor performance for the user. In addition, this solution requires vast bandwidth, which becomes expensive for the broadcaster.

A computer may receive live television content if the computer is equipped with a hardware television tuner and a software television player that presents the received television content. This represents a standalone hardware and software channel. As a result, the content is not integrated with other resources, such as information available on the internet.

It would be desirable to combine broadcast television with internet content in a browser to produce a richer and more personalized viewing experience of live broadcast content.

### SUMMARY OF THE INVENTION

A computer readable storage medium includes executable instructions to adapt live broadcast content for display within a browser. The live broadcast content is displayed within the browser. Internet content related to the live broadcast is also supplied within the browser. Television events that include live broadcast content and corresponding internet content are shared by a group of users. Broadcast content and internet content consumption is tracked.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates a browser with broadcast television and internet content in accordance with an embodiment of the invention.

FIG. 3 illustrates a program guide utilized in accordance with an embodiment of the invention.

FIG. 4 illustrates a browser with broadcast television and accompanying internet content in the form of a listing of individuals participating in a shared viewing and a chat session between individual viewers.

FIG. 5 illustrates a broadcast television event in a web browser in accordance with an embodiment of the invention.

FIG. 6 illustrates a layered program guide utilized in accordance with an embodiment of the invention.

FIG. 7 illustrates a program guide dial utilized in accordance with an embodiment of the invention.

Like reference numerals refer to corresponding parts throughout the several views of the drawings.

### DETAILED DESCRIPTION OF THE INVENTION

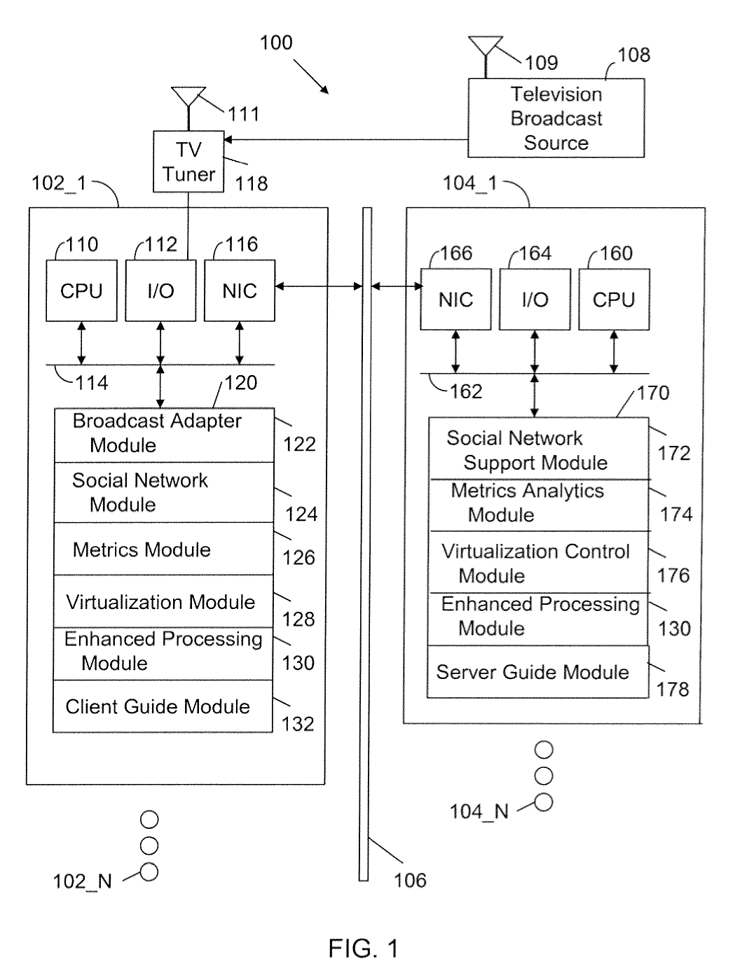

FIG. 1 illustrates a system 100 configured in accordance with an embodiment of the invention. The system 100 includes a set of client computers 102_1 through 102_N coupled to one or more servers 104_1 through 104_N via a communication channel 106. The communication channel 106 may be any wired or wireless infrastructure.

The system 100 also includes a television broadcast source 108. The television broadcast source may be a cable signal provider, a satellite signal provider or an over-the-air signal provider. The broadcast signal may reach a client computer 102_1 by any of these techniques. For example, a cable signal may be received at a TV tuner 118 via a cable link 107. Alternately, an over-the-air signal may be communicated from antenna 109 (or satellite) to antenna 111 (or satellite dish). The particular TV broadcast technique utilized with the invention is insignificant. What is significant is that a standard broadcast signal is combined with internet content to enhance the user experience associated with a broadcast event. The utilization of a broadcast signal avoids the scaling problems associated with prior art streamed events.

Each client computer 102 includes standard components, such as a central processing unit 110 and input/output devices 112 connected via a bus 114. The input/output devices 112 may include a keyboard, mouse, display, printer, and the like. An antenna 111 and associated television tuner 118 may be connected to a port of an input device 112. Alternately, the TV tuner 118 may be a card within the computer 102 (e.g., connected directly to bus 114). The TV tuner 118 allows television signals to be received by the computer 102. A network interface circuit 116 is also connected to the bus 114. The network interface circuit 116 provides interconnectivity to a computer network.

Television tuners rely upon dedicated software to present broadcast content to a user at a client computer. Thus, for example, a window on a monitor of a computer may display broadcast content. In this case, the broadcast content represents a standalone experience. The invention enhances this experience by incorporating broadcast content into a standard browser, thereby removing the need for an independent application. As a result, the browser can display the broadcast content along with internet content. Typically, the internet content is related to the broadcast content, as discussed below and therefore enhances the viewing experience.

As shown in FIG. 1, a computer memory 120 is connected to bus 114. The computer memory 120 includes executable instructions to implement operations of the invention. A broadcast adapter module 122 includes executable instructions to insert a broadcast television signal into a browser. The broadcast adapter module 122 may be configured in any number of ways. Each of the techniques described below overcomes the issue that a browser is configured to retrieve World Wide Web content, such as streamed video or static content, but is not configured for receiving broadcast television content.

In one embodiment, the broadcast adapter module 122 is implemented as a vector and raster graphics player in communication with a client side module operating as a content server. The emulated content server delivers the broadcast television content to the player, which displays the content in a browser. For example, the vector and raster graphics player may be an Adobe® Hash® player (hereinafter Flash). Flash is a widely used multimedia platform that allows one to add animation and interactivity to web pages. Flash also allows one to integrate video into web pages and to develop rich internet applications. Flash has a scripting language called ActionScript® (hereinafter ActionScript). ActionScript is a scripting language for controlling vector animations. ActionScript may be used to connect to servers. In this case, instead of the server being remote, the server is emulated to be on the local host or client. The Flash NetConnection class may be used to create a bidirectional connection between a Flash Player and a Flash Media Server or an application server running a Flash Remoting class. In this case, the server is an emulated content server module on the client.

The broadcast adapter module 122 may also be implemented as a client-side TV Tuner class native to Flash. Flash already has support for client-side classes such as a camera and microphone. These classes are unique in Flash since they specifically communicate with devices that are connected to the user's computer. This implementation provides a clean architecture built upon existing precedence. It also allows for a device process to be started on demand.

The broadcast adapter module 122 may also be implemented by utilizing existing camera and microphone devices to process the broadcast content. That is, existing camera and microphone content processing modules are used to process the video and audio streams of broadcast content. For example, client-side ActionScript classes may be used to emulate camera and microphone devices, which receive a TV tuner stream.

Alternately, the broadcast adapter module 122 may be implemented with executable instructions that transform the broadcast content into an emulated local file that is executed by a vector and raster graphics player. For example, a Flash player may process this content as it would process other audio/visual files.

The broadcast adapter module 122 may also be implemented as a custom browser plug-in. For example, the custom browser plug-in may be combined with ActiveX®, Microsoft's reusable software components that perform specified functions in a programming language independent manner.

Solutions may also be implemented with Microsoft's Silverlight®, which is a programmable web browser plug-in that enables features such as animation, vector graphics and audio-video playback that characterize rich internet applications. Other solutions may be implemented using JavaFX®, which is a software platform for creating and delivering rich internet applications that operate across a wide variety of connected devices. JavaFX is fully integrated with the Java Runtime Environment (JRE). JavaFX applications run on any desktop and browser that runs the JRE and on top of mobile phones running Java ME.

The Flash Player 6 and later versions support video playback. Video can be provided to a Flash Player in a number of ways. First, one can embed video within a SWF file by using SWF video tags. SWF files, an acronym for ShockWave Flash files, are supported by the Adobe Flash player and are identified by a “.swf” file name extension. Video can also be delivered as a video stream over Real Time Messaging Protocol (RTMP), which is a protocol supported by Adobe® for streaming audio, video and data over the internet between a Flash player and a server. In one embodiment, the video data is loaded into an FLV file format. FLV is a container file format used to deliver video over the internet for use by a Flash player. An FLV file can be directly loaded into a Flash Player using the NetStream.play ActionScript method. This method is only available in Flash Player 7 and later. The SWF and FLV file formats share a common video encoding format. As of SWF 7, a video format called screen video is available. Screen video is a simple lossless sequential-bitmap format with blocked inter-framing. It is designed for sending captures of computer screens in action, but can be leveraged for streamed TV video.

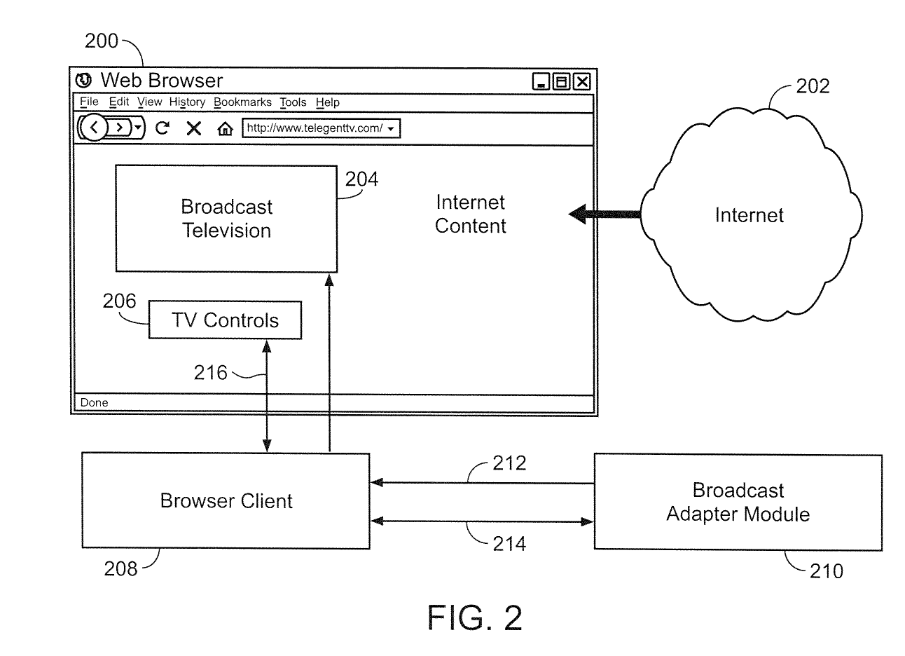

FIG. 2 illustrates a browser 200 connected to the internet 202 to receive standard internet content. The standard internet content includes HyperText Markup Language (HTML) content or other known markup language content.

FIG. 2 also illustrates broadcast television content 204 within the browser 200, effectively coupled with the internet content. The broadcast television content 204 is received from the broadcast adapter module 210, which may be implemented using any of the techniques described above.

In the embodiment of FIG. 2, a browser client 208 operates with the broadcast adapter module 210 to deliver the broadcast content. The broadcast content is delivered on channel 212. A control channel 214 exchanges control commands between the browser plug-in 208 and the broadcast adapter module 210. A control channel 216 is also used between the browser plug-in 208 and a set of user accessible TV controls 206, which may be implemented using the Adobe Flash Player.

Returning to FIG. 1, client device 102 includes a number of additional modules to enhance the broadcast television viewing experience. In one embodiment, a social network module 124 includes executable instructions to support social networking activities associated with a broadcast television event. The social network module 124 may Operate in conjunction with a social network support module 172 in memory 170 of server 104. Alternately, all of the social networking content may be provided to the client 102_1 by the server 104_1. In this case, a user logs into a website, which coordinates content delivery to the browser. Simultaneously, the browser receives broadcast television content from the broadcast adapter module 210.

Server 104 includes standard components, such as a central processing unit 160 connected to input/output devices 164 via a bus 162. A network interface circuit 166 provides connectivity to client devices 102_1 through 102_N and other servers (e.g., 104_N). The server 104 also includes a memory 170 to store modules that implement various functions associated with the invention, as discussed below.

The social network support module 172 and/or social network module 122 operate to facilitate various social interactions associated with a broadcast. These interactions may include chat, instant messaging, wall posts, quizzes, user ratings and newsfeeds served via the internet. Again, this is achieved in conjunction with a broadcast event as opposed to streaming video with its associated limitations for large audiences. The approach of the invention improves the user experience and eliminates costly bandwidth requirements of streaming video over the internet.

One type of social network event supported by the social network module 124 is a television event called a TVchat. A TVchat is a broadcast event simultaneously viewed and chatted about by a group of users. In particular, a TVchat includes live broadcast content and associated internet content shared by the group of users. The associated internet content may be chat information, targeted advertising, links to other websites, and the like.

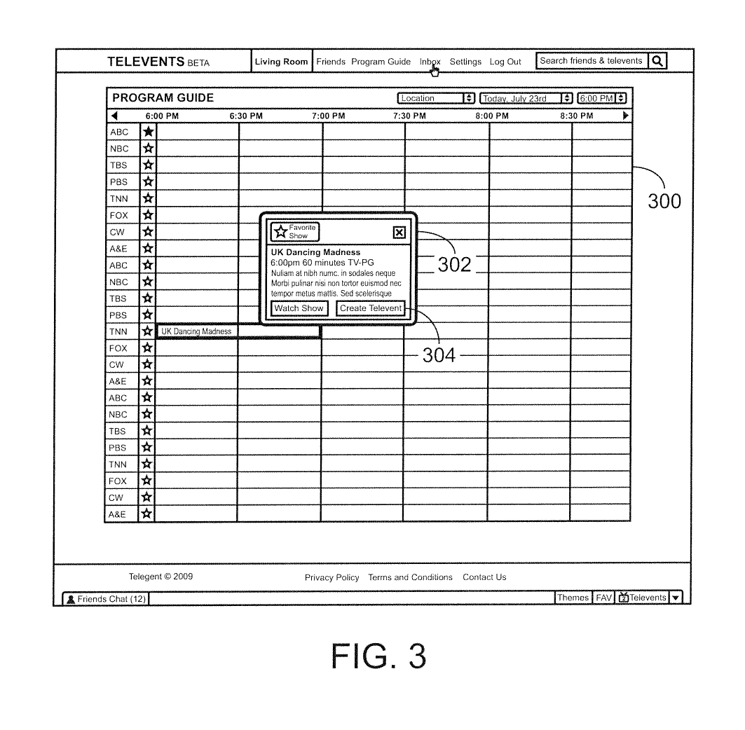

FIG. 3 illustrates a program guide 300 that may appear on a monitor of a client device. Selection of a program results in window 302 describing the program. The window 302 also includes a button 304 to create a TVchat or Televent. Activating the button 304 results in the selection of the program and a menu of options for viewing the event with private or public participants. The menu of options includes a prompt to specify a group of users to share the Televent.

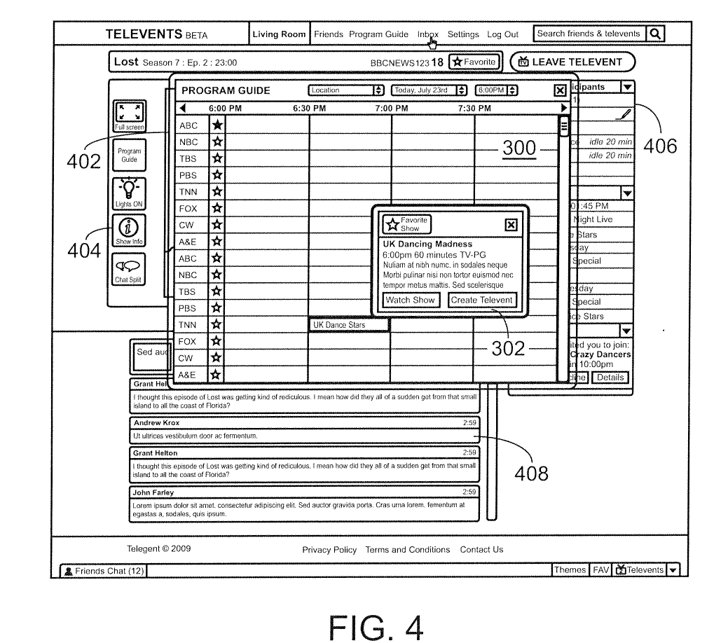

FIG. 4 illustrates broadcast content in window 402 and a set of controls 404 associated with the broadcast content. Panel 406 includes options for specifying participants in the broadcast event. Panel 408 displays a chat session associated with the broadcast event.

Private Televents are organized by an individual for a select group of friends. Once a Televent commences, users visit the host's main page called the “Living Room” to watch the show together and chat in an event-specific chat room, such as panel 408 of FIG. 4.

Public Televents are open to all users. An example of a public Televent is a premier of a new show that a broadcaster wishes to promote by hosting a Televent that any subscriber can attend. The site also supports broadcaster sponsored Televents, where the look and feel of the Televent page is defined by the broadcaster.

A Living Room is the main page of a user. A Living Room typically contains a list of friends online and what they are watching. Preferably, the Living Room includes a customizable background or skin. Users can personalize their living room and their experience applying a skin to the living room, assembling virtual living room objects and arranging the living room display to suit their tastes.

Returning to FIG. 1, the memory 120 may also store a metric module 126 to track viewing information. That is, the metric module includes executable instructions to track user broadcast viewing activity, general user information metrics and corresponding internet content consumption. This information is passed to the metric analytics module 174 of server 104. The information may be used to build a “social meter” which tracks behavior to provide features, such as real-time ratings, most popular shows being viewed, and intelligent TV viewing suggestions.

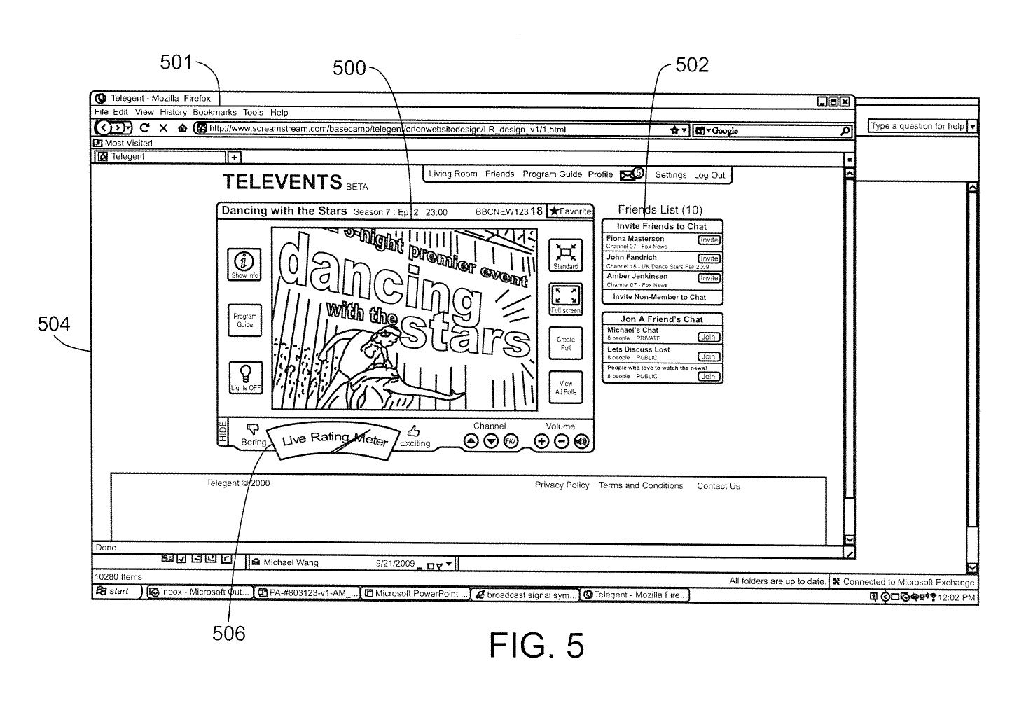

FIG. 5 illustrates a television broadcast 500 within a browser 501. The figure also illustrates a list 502 of friends that are sharing the event. TV controls 504 are also illustrated. Further, the figure illustrates a social meter 506 providing real-time feedback from viewers of the broadcast.

Social data collected allows the metrics analytics module 174 to provide suggestions on where to purchase associated products or view other relevant information related to what the user is watching. For example, users who liked show X may be advised about a similar show Y. The metric analytics module 174 may also track information about users who visit a recommended web site to purchase a sponsored product featured in a broadcast event.

The metrics analytics module 174 captures all user behavior (within applicable privacy laws) and is therefore able to provide real-time analytics about television-watching behaviors. Statistics are collected across the user base for a given user or for a group of users. Additionally, data is collected over time, during a specific episode, across multiple episodes of a series or a sports team local airing. Specific likes and dislikes of a given user can also be collated to help recommend websites. This level of analytics surpasses anything currently available that measures television-watching behavior.

An embodiment of the invention may include a virtualization module 128. The virtualization module 128 includes executable instructions to render virtual objects and/or services during a broadcast. The virtualized content appears as interact content associated with a broadcast event. In one embodiment, the virtualization module 128 receives information from a virtualization control module 176 resident on server 104. The virtualization module 128 allows a user to personalize a viewing experience. Virtual objects, such as a “poster” for a living room wall or a “drink” that one user buys for another can be purchased via micro-transactions or may be “sponsored” by external entities. For example, the Coca Cola Company might give away virtual Coke® bottles to users. Virtual services provide for an enhanced user experience. For example, a virtual concierge may be used to inform a user of unique information about a show. The virtualization control module 176 may also be used for virtual world advertising promotion and placement. This operates as an extension beyond standard banner ads and sponsored links. Virtualization operations may be combined with rewards programs. For example, a user can earn currency online by watching a certain number of hours of a show or channel or by displaying a sponsored link. This currency can then be used to purchase virtual objects and services.

The enhanced processing module 130 at client 102_1 and/or server 104_1 includes executable instructions to support any number of additional features that leverage the functionality of the invention's combined broadcast television and internet content. For example, interactive internet content can enhance an otherwise standard live broadcast. Consider a situation where the director or star of a show comments on the show through an interne feed as the show is broadcasted. Alternatively, hosts that are qualified or just general users of the site can chat about the live TV broadcast in a way that provides interest for other viewers. If two well known movie critics are chatting during a movie, users may tune into the broadcast on the site to supplement their viewing experience. Alternately, users can develop a community or following on their own, based on their knowledge and expertise. An example of this is two users that are fans of a particular football team and are very knowledgeable about statistics, the sport, etc. These users might host a public Televent every time the team plays a game and other users could attend those public Televents and follow the hosts' commentary.

The enhanced processing module 130 may also support mobile entry points via Short Message Service (SMS) messaging or smart phone applications. SMS integration is enabled with a short code for messaging to the site (e.g., server 104_1) and notifications from the site based on user preferences. Smartphone applications and the mobile version of the website allow users to access a subset of the site features on their mobile device, e.g. one can follow a particular Televent when one is not able to watch on a PC or a television, creating a Televent, inviting friends, posting to the personal wall, etc.

The enhanced processing module 130 may also be configured to support peer-to-peer streaming. One of the issues with streaming of video content over the internet is that numerous users go to the same site at the same time to download the same bandwidth-intensive content. This means that servers optimized for sub-peak load will typically fail or significantly degrade the video experience when high traffic exceeds the server optimization level. The enhanced processing module 130 may be used to allow users without a television tuner or with a bad broadcast signal in their watching area to stream content from a peer who is watching the same content received via broadcast. If a high number of users were to do this it would put some strain on internet bandwidth, but that strain would likely be randomly distributed between internet service providers due to the peer-to-peer nature of this method.

The enhanced processing module 130 may also be used to exploit the vertical blanking interval (VBI). The vertical blanking interval is a dead space between frames of video sent and rendered on a television set. Information like closed-captioning text is currently sent in the VBI. In older television sets, this interval needed to be longer than is required today. As a result, now there is an opportunity to send additional data in the broadcast signal. The enhanced processing module 130 deciphers and renders the additional VBI information for viewers.

The system 100 may also be implemented with a server guide module 178 on server 104 and a corresponding client guide module 132 on client 102. Currently, computer TV players extract information from a broadcast to build a channel map—the list of channels, frequencies, and information about what's on what channel at a given time and in the future. The process of collecting this information is very time-consuming as the whole broadcast spectrum must be scanned. The server guide module 178 may use channel map information obtained over the internet and pass that information to the client guide module 132 in order to greatly reduce the amount of processing that is required from the broadcast message and to create a faster, more seamless connection.

The server guide module 178 may provide program information to users in different ways depending on an internal preference algorithm. The traditional Electronic Programming Guide (EPG) that television viewers are familiar with provides a grid pattern with channels listed down the left side, contiguous timeslots listed across the top, and television program information listed in the table created by the two axes. FIG. 3 provides an example of such a traditional paradigm.

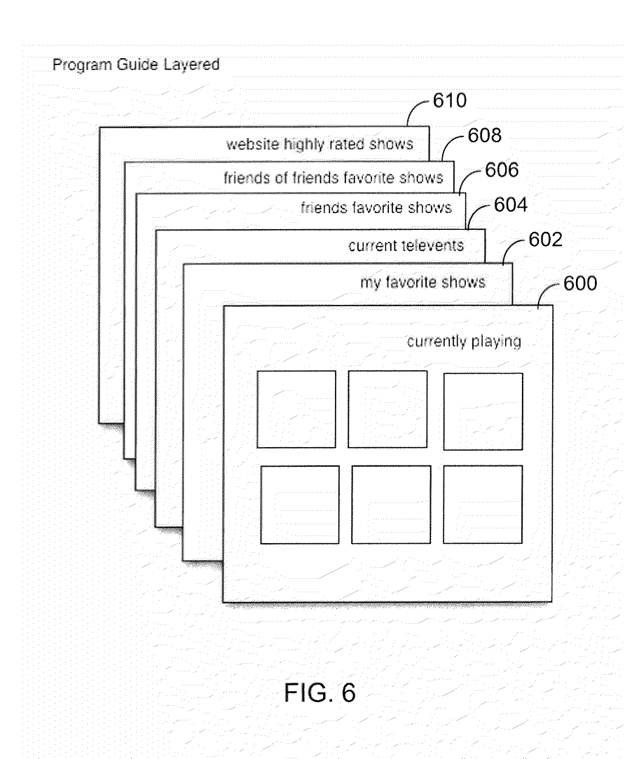

The server guide module 178 may be configured to provide information that does not rely upon a time axis. For example, content views may be supplied based on relevance to certain factors: user-defined or “intelligent/user-behavior determined” selection criteria. All information available may not be visible at one time, and is dependent on the user interface implementation. FIG. 6 provides an example of a layered program guide. The layered program guide includes various layers, where each layer characterizes content in accordance with a specified criteria. For example, the specified criteria may be currently playing content 600, favorite shows 602, current Televents 604, favorite shows of friends 606, favorite shows of friends of friends 608 and highly rated shows 610.

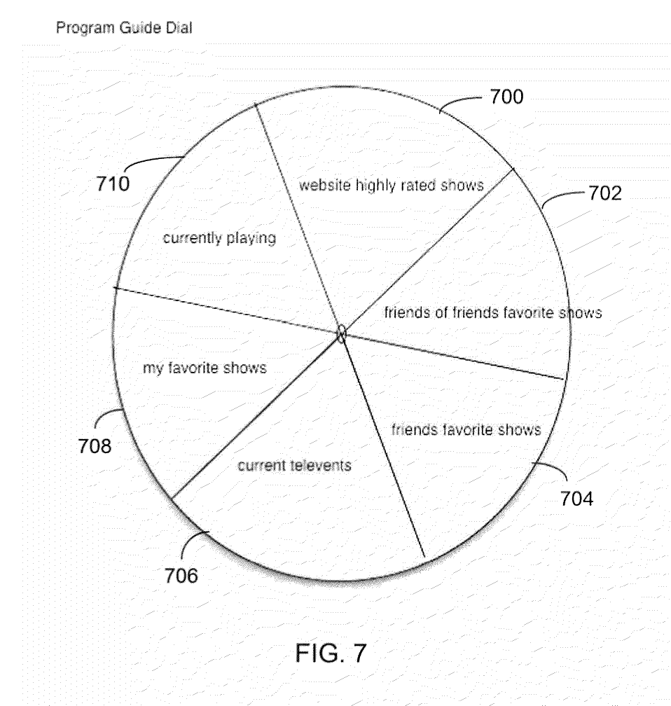

FIG. 7 illustrates an alternate display paradigm using a guide dial with highly rated shows 700, favorite shows of friends of friends 702, favorite shows of friends 704, current televents 706, personal favorite shows 708 and currently playing shows 710.

The user can specify different selection criteria and the broadcast material will be displayed accordingly. Multiple selection criteria or keywords searches, rather than selection from a drop down list, can also be utilized. Finally, intelligent filters may recommend viewing material to the user using settings or information entered by the user. Other analytics that track the user's behavior on the site may also be used. Some of the selection criteria can include:
My favorite shows or channels
Aggregation of my friends' and friends of friends' favorite shows or channels
Favorites across a website
Favorites sorted by criteria, e.g. 20-somethings, gender, sports
Most watched shows or channels within a group of friends
Most watched shows or channels
Highest rated shows per group or by user
For a current selection, recommendations based upon live viewer ratings
Sorting by “most Televented”
Broadcaster influenced weighting
Ratings by friends
Sorting by stars or genre or other criteria noted by the user—essentially tagging shows
Signal strength/quality of signal
Time relevance e.g. shows on now versus later versus previous
The next live broadcast of an episode or show
Recommendations: Friends who liked this also like that
Compatibility across a user's schedule and a friend's schedule (internal and external calendar, where possible)
Likelihood of greater than a certain number of attendees for a Televent, based on friends' schedules
Viewing times based on most available friends
Preferred genre based on user setting
   Other means by which a user is able to sort through viewing material is by color coding of a TV show entry in order to highlight the data. Any of the criteria above can be used to highlight a specific show.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
adapt live broadcast content for display within a browser;
display the live broadcast content within the browser; and
supply Internet content related to the live broadcast within the browser.

2. The computer readable storage medium of claim 1 wherein the executable instructions to adapt include executable instructions to emulate a content server at a client device, wherein the content server delivers the live broadcast content to the browser.

3. The computer readable storage medium of claim 1 wherein the executable instructions to display the live broadcast content include executable instructions defining a vector and raster graphics player.

4. The computer readable storage medium of claim 1 wherein the executable instructions to display the live broadcast content include executable instructions to define a television tuner native to a vector and raster graphics player.

5. The computer readable storage medium of claim 1 wherein the executable instructions to display the live broadcast content include executable instructions to process the live broadcast with native camera and microphone content processing modules.

6. The computer readable storage medium of claim 1 wherein the executable instructions to display the live broadcast content include executable instructions to package the live broadcast content as a local file for processing by a vector and raster graphics player.

7. The computer readable storage medium of claim 1 wherein the executable instructions to display the live broadcast content include executable instructions to define a custom browser plug-in.

8. The computer readable storage medium of claim 1 wherein the executable instructions to supply internet content include executable instructions to supply at least one of chat, instant messaging, quizzes, live ratings, wall posts and newsfeeds served via the internet.

9. The computer readable storage medium of claim 1 wherein the executable instructions to supply internet content include executable instructions to prompt a user to form a television event shared by a group of users, wherein the television event includes the live broadcast content and Internet content shared by the group of users.

10. The computer readable storage medium of claim 1 further comprising executable instructions to track live broadcast content consumption.

11. The computer readable storage medium of claim 10 further comprising executable instructions to track internet content consumption.

12. The computer readable storage medium of claim 10 further comprising executable instructions to direct live broadcast content consumption data to a metric analytics module processing distributed live broadcast content consumption data.

13. The computer readable storage medium of claim 1 further comprising executable instructions to render virtual objects during a broadcast.

14. The computer readable storage medium of claim 1 wherein the executable instructions to supply internet content include executable instructions to supply interactive internet content.

15. The computer readable storage medium of claim 1 further comprising executable instructions to support peer-to-peer streaming.

16. The computer readable storage medium of claim 1 further comprising executable instructions to process data in a vertical blanking interval.

17. The computer readable storage medium of claim 1 further comprising executable instructions to render a layered electronic program guide, wherein each layer characterizes content in accordance with a specified criteria.

18. The computer readable storage medium of claim 1 further comprising executable instructions to render an electronic program guide dial, wherein different segments of the dial characterize content in accordance with a specified criteria.
